(19) United States
(12) Patent Application Publication
(10) Pub. No.: US 2005/0210085 A1
(43) Pub. Date: Sep. 22, 2005

(54) Method for determining a value given to different parameters of a system

(76) Inventor: Pierre Bessiere, Corenc (FR)

Correspondence Address: PLEVY & HOWARD, P.C., P.O. BOX 226, FORT WASHINGTON, PA, 19034, US

(21) Appl. No.: 10/522,655

(22) PCT Filed: Jul. 29, 2003
(86) PCT No.: PCT/FR03/02399

§ 371 Date: Jun. 6, 2005

(30) Foreign Application Priority Data
Jul. 29, 2002 (EP) 023541154

(51) Int. Cl. G06F 1/00

(52) U.S. Cl. 708/100

(57) ABSTRACT

The invention relates to a method for determining a value given to the totality of specific parameters of a system using the values of the totality of measuring parameters of said system which is associated to a unit for providing with a probability value for any combination of values of the specific parameters. The inventive method consists in determining the value of each parameter and in constructing the representation of probability distribution of all possible combination of values of the specific parameters pertaining to determine values. The totality of combinations is divided into a number of first totalities of combinations. Each first totality can be divided into a number of second totalities in a similar manner and so on, a probability value being attributed to each totality. Said method also consists in selecting the totalities of values of the specific parameters using the constructed representation of probability distribution.

The present invention relates to a method for deter-mining the value to be given to a set of so-called specific parameters of a system based on the values of a set of so-called system measurement parameters.

Such a method may be used to control various systems such as a character recognition system, an electric component failure diagnosis system, a system for evaluating a transport cost.

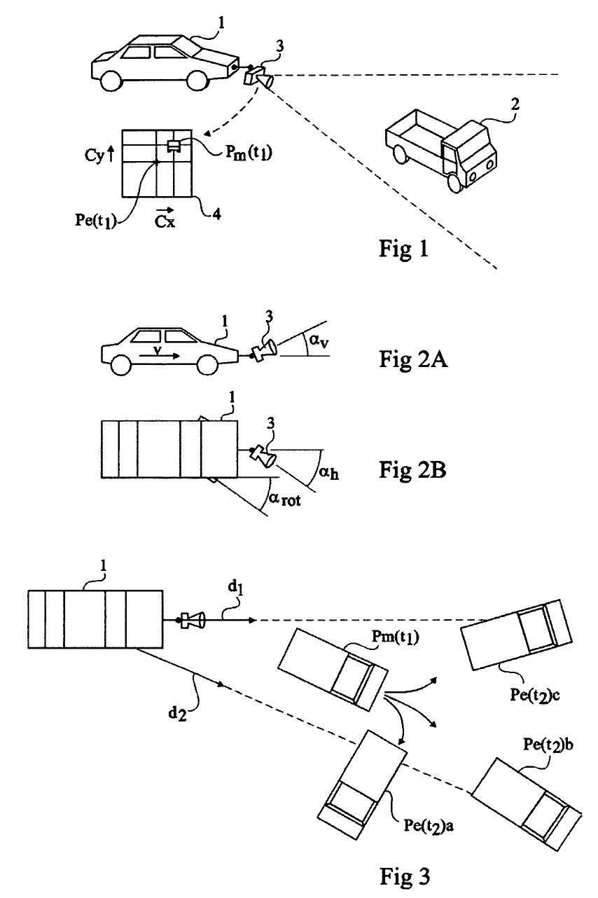

FIG. 1 shows an example of a system using such a method. A car 1 attempts to follow a truck 2, the car and the truck being models moving on a planar obstacle-free surface. The car is equipped with a camera 3 and with an autonomous control system. The control system has the function of defining at regular intervals, for example, every 100 ms, the direction and the speed that must be taken by car 1, as well as the inclination of the camera so that the truck permanently remains in the camera's field of vision.

At a given time to, the control system estimates where the truck will be 100 ms later, at a time t₁. In the case where the truck effectively moves as expected, it will be at the estimated position Pe(t₁), at the center of image 4 that the camera will take at time t₁. However, generally, the truck will be at a measured position Pm(t₁) different from Pe(t₁). Position Pm(t₁) is shifted in the x and y direction with respect to Pe(t₁) according to a horizontal shift cₓ and a vertical shift c_{y}. Horizontal shift cₓ indicates whether the truck has moved more to the left or to the right. Vertical shift c_{y} indicates whether the truck has accelerated or slowed down.

FIG. 2A is a side view of car 1 moving at speed v provided with camera 3, and shows the vertical inclination angle αᵥ of the camera's axis. FIG. 2B is a top view of car 1, and shows horizontal inclination axis αₕ of the camera's axis, as well as rotation angle αᵣₒₜ of the wheels of car 1.

FIG. 3 shows a possible configuration of car 1 and of truck 2, at time t₁, truck 2 being at position Pm(t₁) of FIG. 1. The truck would thus seem to go rightwards (assumption a). The truck may also go forwards and accelerate (assumption b). The truck may also start back off to the left (assumption c). It will be considered hereafter that the truck has but these three possibilities and is only likely to go to one of the three estimated positions Pe(t₂)a, Pe(t₂)b, and Pe(t₂)c.

The car control system must then decide whether the car must take direction d₁ enabling joining truck Pe(t₂)c or whether it must take direction d₂ enabling joining the truck at position Pe(t₂)a or Pe(t₂)c. Since the three possibilities Pe(t₂)a, Pe(t₂)b, and Pe(t₂)c are a priori equiprobable, the selection of direction d₂ seems to be the most judicious since it covers a larger number of possibilities, and it will be considered hereafter that d₂ has been selected.

The control system must then choose to increase or decrease speed v of car 1. The image analysis enables thinking that the truck has accelerated since it is at the top of the image. A first decision could be to require an acceleration of the car. However, the control system has chosen to go in direction d₂ and it is possible for the truck to smoothly turn rightwards to reach to the position of truck Pe(t₂)a. Knowing this probability, it then seems judicious not to accelerate too much to avoid colliding with the truck.

The control system similarly defines angles αᵥ and αₕ to be given to the camera according to the previously-taken decisions and to the estimate of the future displacement of the truck.

The control system of car 1 must be able to define the new values of parameters v, αᵣₒₜ, αᵥ and αₕ, with a small-size and low-cost calculator and memory. It is further necessary for the control system to take decisions quickly, every 100 ms. The control system must also process a large number of measurement parameters cₓ, c_{y} and of specific or, more specifically, of control parameters v, αᵣₒₜ, αᵥ, αₕ to be able to take efficient decisions that enable following the truck whatever its trajectory.

The forming of a control system requires previously defining the interdependencies between parameters. Thus, in the above-described example, the selection of horizontal inclination angle αₕ and of rotation angle αᵣₒₜ depends on the measured horizontal shift cₓ; the selection of vertical inclination angle αᵥ and the selection of speed v depend on the measured vertical shift c_{y}. Further, angle αₕ and angle αᵣₒₜ are dependent from each other, otherwise the truck risks coming out of the field of vision of the camera, whereby the car can then no longer follow the truck. Similarly, speed v and angle αᵥ are dependent from each other, angle αᵥ having to be adapted to the speed and vice versa.

A model of the joint probability distribution of all the system parameters is defined based on a set of independent probability distributions defined for each of the previously identified interdependencies. Thus, probability p(v, αᵣₒₜ, αᵥ, αₕ, cₓ, c_{y}) for a given combination of values of all the parameters to be possible and clever, can be defined for the above-described set by the following formula:
p(v, αᵣₒₜ, αᵥ, αₕ, cₓ, c_{y})=p(cₓ)p(c_{y})p(αₕ/cₓ)p(αᵥ/c_{y})p(αᵣₒₜ/αₕ)p(v/αᵥ) (1)
where p(cₓ) is the probability for horizontal shift cₓ to have a given value, p(c_{y}) is the probability for vertical shift c_{y} to have a given value, p(ah/cₓ) is the probability to have a horizontal inclination angle αₕ knowing shift cₓ, p(αᵥ/c_{y}) is the probability to have a vertical inclination angle αᵥ knowing shift c_{y}, p(αᵣₒₜ/αₕ) is the probability to have a rotation angle αᵣₒₜ knowing angle αₕ, and p(v/αᵥ) is the probability to have a speed v knowing angle αᵥ.

Simple non-conditional probabilities, such as p(cₓ), may be defined by an analytic function, for example, p(cₓ)=(absolute value of k/cₓ) where k is a normalization constant. Similarly, conditional probabilities, such as p(αₕ/cₓ), may be defined by a family of analytic functions, that may for example be gaussian functions centered on value cₓ.

Simple probabilities, p(cₓ), or conditional probabilities, p(αₕ/cₓ), can also be calculated from a database indexing the number of times when a horizontal shift cₓ or a couple of values (ah, cₓ) has been observed, for example, in a training phase.

The joint probability distribution model, the analytic functions, and the databases are memorized. After an image has been taken at a time tᵢ, the control system must decide of the value to be given to each control parameter v, αᵣₒₜ, αᵥ, αₕ based on the values noted down for each measurement parameter at time tᵢ, cₓᵢ, and c_{yi}. The system first selects a couple of values (αᵣₒₜ, v), then, after, the other couple of values (αᵥ, αₕ). Only the selection of a couple (αᵣₒₜ, v) will be described, the selection of a couple (αᵥ, αₕ) being performed identically. Probability p(αᵣₒₜ,v/cₓᵢ,c_{yi}) for the selection of a couple (αᵣₒₜ,v) to be pertinent knowing shift values cₓᵢ and c_{yi} can be calculated according to the following formula:

$$p ( {α}_{rot} , v / {c}_{xi} , {c}_{yi} ) = \frac{1}{Z} {\sum }_{{α}_{v} , {α}_{h}} p ( v , {α}_{rot} , {α}_{v} , {α}_{h} , {c}_{xi} , {c}_{yi} ) \qquad ( 2 )$$

where Z is a normalization constant.

There are two sorts of existing control systems capable of selecting a couple (αᵣₒₜ,v) based on the probability distribution of the couples. The first ones select a couple (αᵣₒₜ,v) directly from formula (2). The second ones construct, prior to the selection of a couple (αᵣₒₜ,v), a representation of the probability distribution of the couples.

Among the first systems, so-called optimization methods which search the maximum probability and select the corresponding couple can be mentioned. Now, it may be preferable to select a couple which does not exhibit a probability maximum. For example, in the case where the probability distribution exhibits several maximums for two couples (α_{rot,1},v₁) and (α_{rot,2},v₂), it may be pertinent to select a couple having a speed intermediary between v₁ and v₂ and a rotation angle between α_{rot,1} and α_{rot,2}. Other methods such as the METROPOLIS method (see “Monte Carlo simulation and numerical integration” by J. Geweke, 1996), perform a random drawing of a couple directly from formula (2). Such methods implement calculation algorithms, for the most part very complex and use powerful calculators. Such methods further require a significant calculation time, incompatible with certain uses such as that described in FIG. 1.

Among the second systems, certain methods use a so-called tabular representation of the probability distribution. This tabular representation consists of memorizing, for each couple (αᵣₒₜ,v), probability p(αᵣₒₜ,v/cₓᵢ,c_{yi}) obtained for the shifts cₓᵢ, c_{yi} measured at time tᵢ. The selection of a couple may then consist of taking the maximum probability couple, or of performing a random drawing of a couple from the memorized data.

In the case where the studied parameters are numerous, or when a parameter can take many values, the calculation time of the probabilities of each couple (αᵣₒₜ,v) quickly becomes very long. The size of the memory used to store the tabular representation may also quickly become prohibitive.

A representation of the probability distribution, known as a “gaussian mixture”, consists of modeling the distribution by a set of gaussian functions, each gaussian function being defined from a maximum probability value. Previously, an optimization method is used to identify the couples (αᵣₒₜ,v) of maximum probabilities. The couples are then distributed in groups containing more or less couples according to whether the couples have or not values αᵣₒₜ and v close to the identified maximums. A probability value is calculated for each group, the probability values forming gaussians around the maximum probabilities. The selection of a couple is then performed by random drawing or search of the couple of maximum probability.

This method enables having a more or less accurate representation according to the available memory space. However, an increase in the accuracy of the representation requires a new distribution of the couples and a new calculation of the probabilities of each group. Further, the modeling of the probability distribution by a set of gaussian functions is not adequate for all systems.

An object of the present invention is to provide a method for determining the values to be given to one or several specific parameters of a system knowing one or several measurement parameters, in the case where the number of parameters is very large and/or in the case where some of the parameters may take a great number of values.

Another object of the present invention is to provide a method for determining the values to be given to all the specific parameters of a system within a time interval that can be very short.

Another object of the present invention is to provide such a determination method using a memory of variable size and possibly very small.

Another object of the present invention is to provide such a determination method using a simple calculation device.

To achieve these objects, the present invention provides a method for determining the value to be given to a set of specific parameters of a system based on the values of a set of measurement parameters of this system, where each of the parameters can take a finite number of values, the system being associated with a means for providing a probability value for any combination of values of the specific parameters, said probability value being all the greater as the selection of the considered combination is pertinent knowing the value of the measurement parameters, the method comprising the steps of:
noting down the value of each measurement parameter;
constructing a tree-shaped representation of the probability distribution of all the possible combinations of values of the specific parameters corresponding to the noted down values, the set of combinations, forming a first branch, being divided into several subsets of combinations, forming second branches, each subset gathering combinations having close specific parameter values, where each second branch can similarly divide into several third branches and so on, a probability value being assigned to each branch, this probability value being that obtained for one of the combinations of the considered branch or for one of the combinations of one of the branches from which the considered branch originates;
selecting according to a predefined selection criterion one of the combinations of values of the specific parameters based on the representation of the previously-constructed tree-shaped probability distribution.

According to an implementation mode of such a method, the branches resulting from the division of a same branch are at the number of two and contain the same number of combinations, the first branch dividing in two second branches, where each second branch can divide in two third branches and so on.

According to an implementation mode of such a method, the division of a branch in two branches comprises the steps of:
a) selecting a combination different from the combinations having already been used to define the probability value of the existing branches and calculating the probability of this selected combination;
b) dividing the so-called “parent” branch containing the selected combination in two so-called “child” branches; and
in the case where the selected combination and the “parent” combination used to define the probability value of the parent branch belong to the same child branch, assigning to the two child branches the probability value of the parent branch and dividing the child branch containing the selected combination by resuming the method at step b), this child branch becoming the parent branch, and
in the case where the selected combination and the parent combination do not belong to the same child branch, assigning the probability value of the selected combination to the child branch containing the selected combination and assigning the probability value of the parent combination to the other child branch.

According to an implementation mode of such a method, the selection criterion consists of selecting one of the combinations exhibiting the maximum probability.

According to an implementation mode of such a method, the selection of a combination consists of implementing the recursive method comprising the steps of:
a) randomly selecting a number p ranging between 0 and 1;
b) calculating the sum of the probability values assigned to the two so-called child branches resulting from the division of the first branch, and calculating for each child branch a new probability value equal to the ratio between the probability value assigned to this child branch and the calculated sum;
c) defining two contiguous probability intervals between 0 and 1, the first interval being associated with a first child branch, the second interval being associated with the second child branch, the first interval ranging from 0 to and including the probability value of the first child branch and the second interval ranging from this probability value to 1;
d) identifying in which interval number p is to be found and selecting the child branch associated with this interval, and
in the case where the selected child branch ramifies into other branches, resuming the recursive method at step a), the first branch being replaced with the selected child branch, otherwise
e) selecting one of the combinations of the selected child branch.

According to an implementation mode of such a method, the selection criterion consists of selecting one of the combinations having a probability value which is predetermined or ranging between two given probability values.

According to an implementation mode of such a method, the probability values assigned to each branch are not normalized and can be greater than one.

According to an implementation mode of the above-described method, a weighting is assigned to each branch, the weighting of the branches of the last ramifications being equal to the product of the probability value assigned to this branch and of the number of combinations of this branch, the weighting of the other branches being equal to the sum of the weightings of the branches originating from the considered branch and being on the next ramification level.

According to an implementation mode of the above-described method, the probability value assigned to each branch can be normalized, the normalized probability value of a branch being obtained by dividing the probability value of this branch by the weighting assigned to the first branch of the tree.

According to an implementation mode of such a method, the selection of a combination is performed by implementing a method generating combinations having high probability values.

According to an implementation mode of such a method, the representation of the probability distribution of all the combinations is memorized and may be subsequently refined by the creation of additional branches, or may be simplified by the suppression of certain branches.

According to an implementation mode of such a method, the number of values likely to be taken by a parameter is artificially increased, the probability value of a combination of values of control parameters, among which at least a value of one of the parameters corresponds to an added value, is zero.

The foregoing objects, features, and advantages of the present invention will be discussed in detail in the following non-limiting description of specific embodiments in connection with the accompanying drawings, among which:

FIG. 1 shows a car attempting to follow a truck;

FIG. 2A illustrates a side view of the car of FIG. 1;

FIG. 2B illustrates a top view of the car of FIG. 1;

FIG. 3 illustrates a possible configuration of the car and of the truck as well as three future possible positions of the truck;

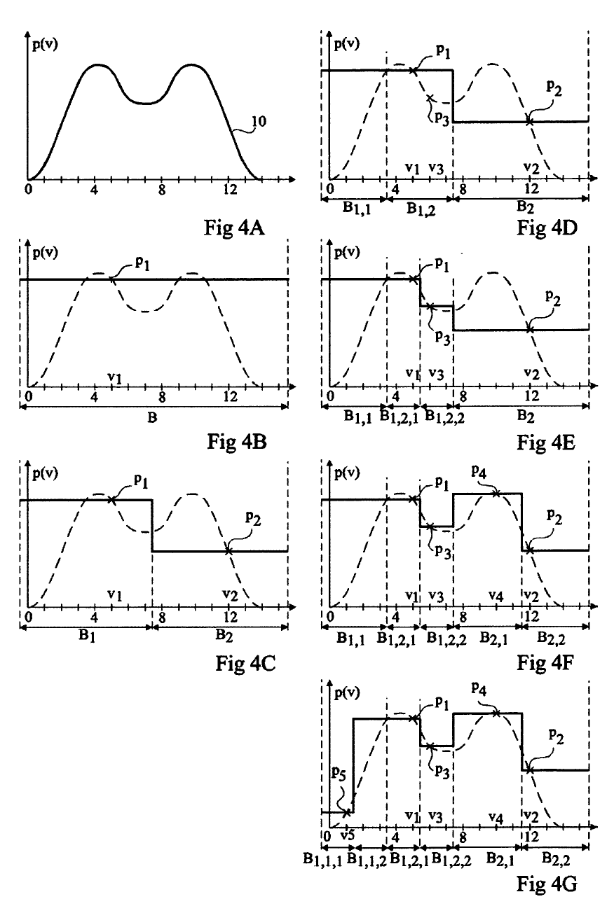

FIGS. 4A to 4G illustrate steps of a method according to the present invention of construction of a representation of a probability distribution;

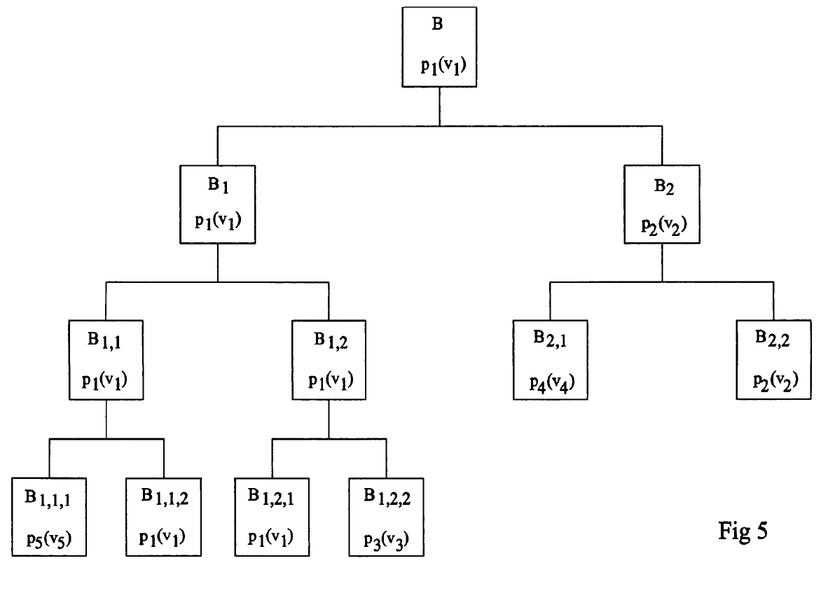

FIG. 5 illustrates in the form of a ramified tree the steps of FIGS. 4B to 4G;

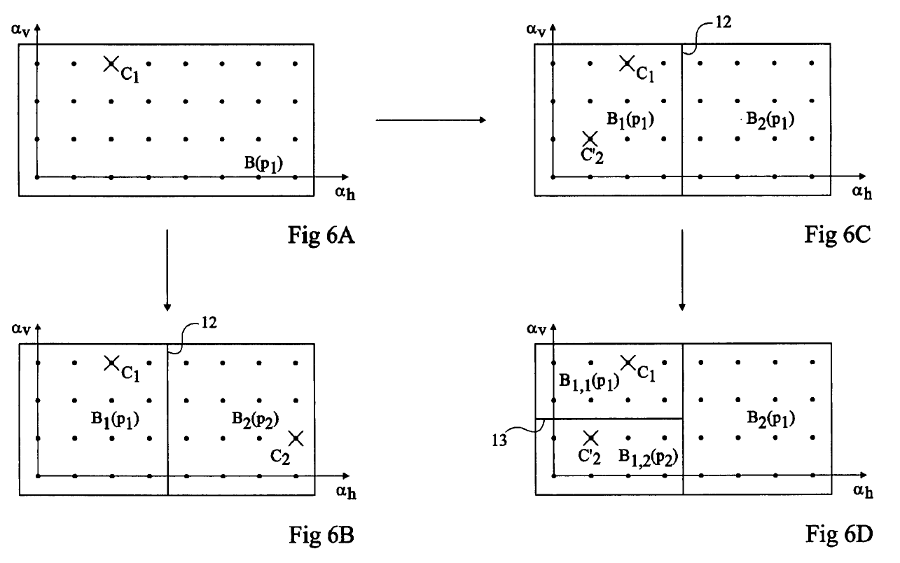

FIGS. 6A to 6D illustrate two possible division modes of the set of couples (αᵥ,αₕ) according to the method of the present invention;

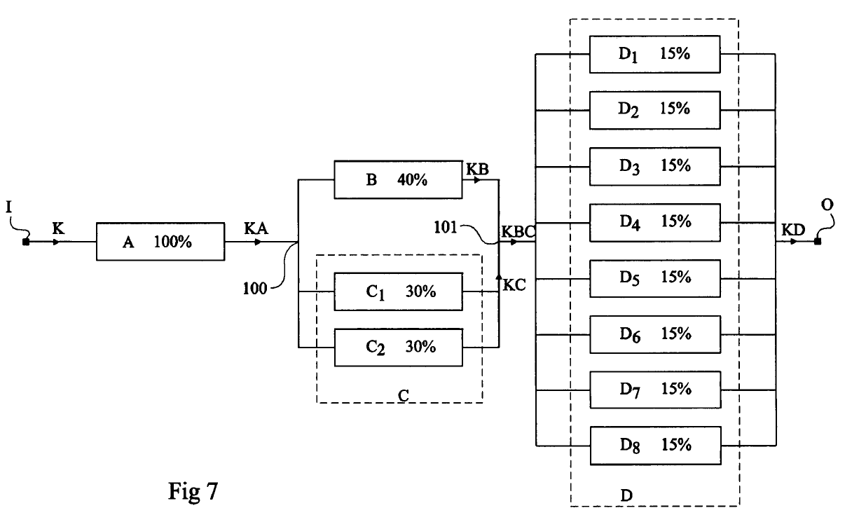

FIG. 7 illustrates an application of the method of the present invention to the failure diagnosis of an electric component assembly; and

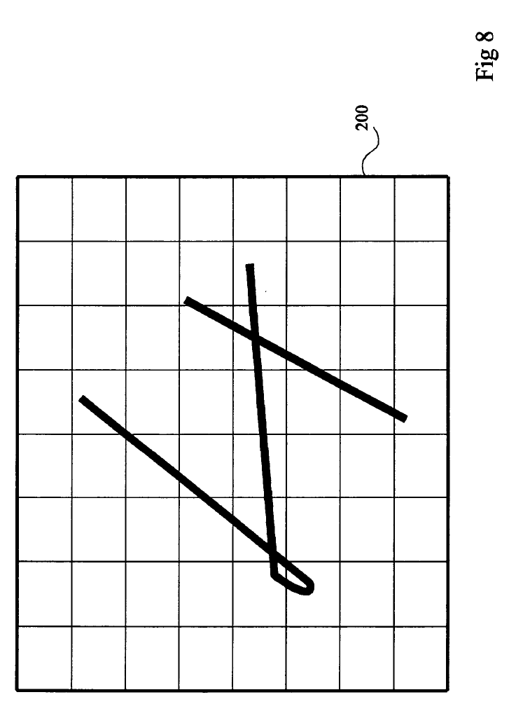

FIG. 8 illustrates an application of the method of the present invention to the recognition of figures.

The method of the present invention applies to any system defined according to the criteria discussed hereafter. It can be decided of the value to be given to n specific parameters XS₁ to XSₙ of the system, knowing the values of n measurement parameters XM₁ to XMₘ corresponding to a determined state of the system. Each of the parameters can take a finite number of values. The values of the specific parameters form a continuous sequence of integers. The measurement parameters may be symbolic variables, where the possible values can be yellow, blue, green, and red. A model of the joint probability distribution of the set of system parameters is known and the probability p(XS₁, . . . , XSₙ,XM, . . . ,XMₘ) for a given combination of all the parameters (XS₁, . . . ,XSₙ,XM₁, . . . ,XMₘ) to be pertinent is calculated. The analytic functions and the databases used by the probability distribution model of the system are known.

At any time, it is possible to make from the system model an inference consisting of defining the probability distribution of the combinations of values of all or part of the specific parameters, for example (XS₁,XS₂,XSₙ), knowing the values of all or part of the measurement parameters, for example, (XM₁,XM₃). Probability p(XS₁,XS₂,XSₙ/XM₁,XM₃) for the selection of a combination (XS₁,XS₂,XSₙ) to be pertinent knowing the values of measurement parameters (XM₁,XM₃) is defined by:

$$p ( {XS}_{1} , {XS}_{2} , {XS}_{n} / {XM}_{1} , {XM}_{3} ) = \frac{1}{Z} {\sum }_{\begin{matrix}{XS}_{3} , … , {XS}_{n - 1} , \\ {XM}_{2} , {XM}_{4} , … {XM}_{m}\end{matrix}} p ( {XS}_{1} , … , {XS}_{n} , {XM}_{1} , … , {XM}_{m} ) \qquad ( 3 )$$

where Z is a normalization constant.

After noting down the considered measurement parameters, the present invention provides a method for constructing a representation of the probability distribution of the combinations of the values of the k selected specific parameters, obtained for the noted down values. A combination of values of the k selected parameters will be called “a combination” hereafter. The set of combinations may be represented by a set of points defined in a k-dimensional space E. The probability distribution is then represented in a k+1-dimensional space.

The construction method of the present invention aims at dividing space E into several sets of points and at assigning an identical probability value to all the points of a same set to obtain a representation of the probability distribution of the combinations.

Once the representation of the probability distribution of the combinations has been obtained by the method of the present invention, the selection of a combination is performed according to one of several selection criteria.

There can be a great variety of applications of the method of the present invention, as will appear from the reading of the mentioned examples.

In a first part, a method for constructing a representation of the probability distribution of the combinations will be described.

In a second part, different selection criteria will be described.

In a third part, examples of application of the method of the present invention will be described.

1. Construction Method

1.1. General Principle

The method for constructing a representation of the probability distribution of the combinations consists of successively selecting different combinations from among the set of possible combinations and of calculating their respective probability values. After each selection of a combination, the set of points of space E containing the selected combination is divided into several sets of points. The set of points containing the selected combination takes the probability value of this combination. The other sets of points keep the probability value that they had before the division.

Initially, space E is not divided and all the points of space E take probability value p₁ of the first selected combination C₁.

The selection of a second combination C₂, different from the first selected combination C₁, causes a division of space E into several sets of points, the set of points containing the second selected combination C₂ taking probability value p₂ of the second selected combination C₂, the other sets of points taking probability value p₁ of the first selected combination C₁.

The selection of a third combination C₃, different from the first and second selected combinations C₁ and C₂, causes the division of the set of “parent” points containing the third selected combination C₃ into several sets of “child” points containing the third selected combination C₃ taking probability value p₃ of the third selected combination, the other sets of “child” points taking the probability value of the set of “parent” points, p₁ or p₂.

The selection of a possible fourth combination C₄, different from those selected previously, would cause a new division of the set of “parent” points containing the fourth selected combination C₄ into several sets of “child” points, the set of “child” points containing the fourth selected combination C₄ would then take probability value p₄ of the fourth selected combination C₄, and the other sets of “child” points would take the probability value of the set of “parent” points p₁, p₂, or p₃.

This construction method can be repeated as many times as possible according to the available time. The representation of the probability distribution will be all the more accurate as the number of selected combinations is large. Conversely to the creation of a representation according to the “gaussian mixture” method, the construction method of the present invention can be executed for a variable time, where the selection of the execution time can be adapted to each system.

The successively-selected combinations can be obtained according to a pseudo-random method generating combinations uniformly distributed over space E or according to an optimized method generating combinations having high probability values.

According to an implementation mode of the method of the present invention, each set of “child” points, resulting from the division of a set of “parent” points, comprises an identical number of combinations.

1.2. Construction Tree

The present invention provides keeping a trace of the construction of the probability distribution via a construction tree.

The first branch of the construction tree represents space E and takes probability value p₁ The first branch ramifies into second branches each representing one of the sets of points resulting from the division of space E. Each second branch takes the probability value of the points of the second considered branch.

The second branch associated with the set of “parent” points containing the third selected combination C₃ ramifies into third branches each representing one of the sets of “child” points. Each third branch takes the probability value of the points of the third considered branch.

Generally, each second branch is likely to ramify into several third branches according to the new selected combinations. Each third branch can ramify into several fourth branches and so on.

The construction tree is memorized along its construction. The end branches of the tree give the final division of the set of combinations. The final representation of the probability distribution will be used hereafter to select one of the combinations, as will be described in the second portion. It may be provided to construct a representation of the probability distribution which is more or less accurate according to the available memory.

The creation of a construction tree has several advantage, as will be specified hereafter, especially for the obtaining of normalized probability values and for the selection of a combination by random drawing according to a random drawing method of the present invention.

1.3. Illustration for the Car/Truck System

1.3.1 Selection of a Speed

The construction of a representation of the probability distribution of the combinations according to the method of the present invention is illustrated hereafter for the previously-described car/truck system.

The case where the car control system decides of the values to be given to control parameters (αᵣₒₜ, v, αᵥ, αₕ) one after the others is first considered. In the case of a speed selection, probability p(v) for the selection of a speed v at a time tᵢ to be pertinent, knowing shift values cₓᵢ and c_{yi} noted down at time tᵢ, can be calculated as follows:

$$p ( v / {c}_{xi} , {c}_{yi} ) = \frac{1}{Z} {\sum }_{{α}_{v} , {α}_{h} , {α}_{rot}} p ( v , {α}_{rot} , {α}_{v} , {α}_{h} , {c}_{xi} , {c}_{yi} )$$

FIG. 4A shows a probability distribution 10 of the speed values obtained for shift values cₓ₀ and c_{y0} noted down at time t₀. This distribution is that of which an approximation is desired to be obtained, simply, rapidly, and minimizing the used calculation and memorization means. Speed v may take an integral value ranging between and including 0 and 15 km/hour. The speed is shown in abscissas, probability p(v) is shown in ordinates. In this example, probability distribution 10 of the speed values is a continuous function which is 0 when the speed is zero or greater than 14 and which exhibits two maximum values for speeds v equal to 4 km/h and 10 km/h.

FIGS. 4B to 4G altogether illustrate the construction of a representation of the probability distribution of FIG. 4A. The sets of speed values, or branches, are shown by a two-way arrow positioned under the speed values belonging to the branch. A horizontal line cutting probability distribution 10, and placed above a two-way arrow, shows the probability value associated with the speed values of the branch shown by the two-way arrow.

FIG. 4B illustrates a first step of the construction linked to the selection of a first speed value v₁ equal to 4 km/h of probability p₁, where the set of speed values, forming a first branch B, takes probability value p₁.

FIG. 4C illustrates a second step of the construction linked to the selection of a second speed value v₂ equal to 12 km/h, of probability p₂. The set of speed values is divided in two sets of speed values forming each of second branches B₁ and B₂. Branch B₁ gathers the smallest speed values ranging from 0 to 7 km/h. Branch B₂ gathers the highest speed values ranging from 8 to 15 km/h. The two branches B₁ and B₂ gather a same number of speed values. Branch B₂ contains the second selected speed value v₂, it thus takes probability value p₂. Branch B₁ keeps probability value p₁.

According to a first aspect of the implementation mode of the method of the present invention selected for this example, the ramification of a branch results in the creation of two branches comprising a same number of speed values, one of the branches comprising the smallest speed values, the other branch comprising the highest speed values.

FIGS. 4D and 4E illustrate two phases of a third step of the construction linked to the selection of a third speed value v₃ equal to 6 km/h of probability value p₃. In a first phase, branch B₁ containing the third selected speed value v₃ ramifies in two branches B_{1,1} and B_{1,2} as appears in FIG. 4D. Branch B_{1,1} gathers the speed values ranging from 0 to 3 km/h, branch B₁, ₂ gathers the speed values ranging from 4 to 7 km/h. The first and third selected speed values v₁ and v₃ belong to the same branch B_{1,2}. In this case, branches B_{1,1} and B_{1,2} keep probability value p₁ The ramification method will carry on (FIG. 4E) until one of the branches only contains the third speed value v₃.

According to a second aspect of the implementation mode of the method of the present invention selected for this example, the ramification of a “parent” branch containing the last selected speed value carries on until a “child” branch only contains the new selected speed value and no other previously-selected speed value. The intermediary “child” branches take the probability value of the “parent” branch.

FIG. 4E illustrates the second phase of the third step. Branch B_{1,2} containing the third selected speed value v₃ thus ramifies in two branches B_{1,2,1} and B_{1,2,2} respectively comprising speed values 4.5 and 6.7 km/h. Branch B_{1,2,2} only contains the third selected speed value v₃ and no other selected speed value. Probability value p₃ is thus assigned to branch B_{1,2,2}. Branch B_{1,2,1} keeps probability value p₁ of branch B_{1,2} from which it originates.

FIG. 4F illustrates a fourth step of the construction linked to the selection of a fourth speed value v₄ equal to 10 km/h of probability value p₄. Branch B₂ containing the fourth selected speed value v₄ ramifies in two branches B_{2,1} and B_{2,2}, the branches respectively gathering speed values 8 to 11 and 12 to 15 km/h. The fourth speed value v₄ belongs to branch B_{2,1} and no other selected speed value belongs to this branch. Probability value p₄ is then assigned to branch B_{2,1}. Branch B_{2,2} keeps probability value p₂.

FIG. 4G illustrates a fifth step of the construction linked to the selection of a fifth speed value v₅ equal to 1 km/h, of probability p₁. Branch B_{1,1} containing the fifth selected speed value v₅ ramifies in two branches B_{1,1,1} and B_{1,1,2} the branches respectively gathering speed values 0, 1 and 2, 3 km/h. The fifth selected speed value v₅ only belongs to branch B_{1,1,1} and no other selected speed value belongs to this branch. Probability value p₅ is then assigned to branch B_{1,1,1}. Branch B_{1,1,2} keeps probability value p₁. It should be noted that at this last stage, a good approximation of probability distribution 10 of FIG. 4A has been obtained.

FIG. 5 shows the construction tree of the representation of the probability distribution of the speed values obtained according to the five steps described in relation with FIGS. 4A to 4G. Branch B of probability value p₁ ramifies in two branches B₁ and B₂ of respective probability values p₁ and p₂. Branch B₂ ramifies in two branches B_{2,1} and B_{2,2} of respective probabilities p₁ and p₂. Branch B₁ ramifies in two branches B_{1,1} and B_{1,2} of probability value p₁ Branch B_{1,1} ramifies in two branches B_{1,1,1} and B_{1,1,2} of respective probability values p₅ and p₁. Branch B_{1,2} ramifies in two branches B_{1,2,1} and B_{1,2,2} of respective probability values p₁ and p₃. The final division of the set of speed values is provided by the end branches of the construction tree.

1.3.2. Selection of Angles (αₕ,αᵥ)

The construction of a representation of the probability distribution of the combinations according to the method of the present invention is illustrated hereafter in the case where the car control system decides of the values to be given to two control parameters.

FIGS. 6A to 6D show the two-dimensional space E of all the couples of values of horizontal and vertical inclination angles (αₕ,αᵥ). A couple of horizontal and vertical inclination angles (αₕ,αᵥ) will be called a couple hereafter. Horizontal inclination angle αₕ is shown in abscissas. Vertical inclination angle αᵥ is shown in ordinates.

Probability p(αₕ,αᵥ/cₓᵢ,c_{yi}) for the selection of a couple (αₕ,αᵥ) to be pertinent knowing shift values cₓᵢ and c_{yi} can be calculated according to the following formula:

$$p ( {α}_{h} , {α}_{v} / {c}_{xi} , {c}_{yi} ) = \frac{1}{Z} {\sum }_{{α}_{rot} , v} p ( v , {α}_{rot} , {α}_{v} , {α}_{h} , {c}_{xi} , {c}_{yi} ) \qquad ( 4 )$$

where Z is a normalization constant and p(v,αᵣₒₜ,αᵥ,αₕ,cₓ,c_{y}) is calculated according to formula (1).

The implementation mode of the method of the present invention for this example uses the first and second above-described aspects. The branches resulting from a ramification are at the number of two and contain the same number of couples. The ramification of a branch carries on until the last selected couple is the only selected couple of one of the branches.

Horizontal inclination angle αₕ can take six values between 0° and 5°, vertical inclination angle αᵥ can take four values between 0° and 3°.

To simplify the computer processing, the number of values likely to be taken by a parameter, if it is not a power of two, is increased to the immediately greater power of two. The probability of the couples having one of their parameters corresponding to an added value (not initially provided) is zero.

In this example, horizontal inclination angle αₕ can initially take six values. The number of values is thus artificially brought to 8 (2³), and the possible values now are from 0° to 7°. No increase in the number of values is performed for vertical inclination angle αᵥ for which 4 (2²) values are possible.

FIG. 6A shows the set of couples (αₕ,αᵥ) forming first branch B. As previously, a first couple C₁ (αₕ₁=2, αᵥ₁=3) and the probability value p₁ calculated for the first couple C₁ is assigned to all the couples of branch B.

FIG. 6B illustrates a possible ramification of branch B after selection of a second couple C₂ (αₕ₂=7, αᵥ₂=4) of probability p₂. Branch B ramifies in two branches B₁ and B₂ according to a vertical limit 12 passing between horizontal inclination angle values 3° and 4°. Branch B₁ gathers the couples having a horizontal inclination angle strictly smaller than 4 (2²). Branch B₂ gathers the couples having a horizontal inclination angle greater than 4 (2²).

According to an aspect of the implementation mode of the method of the present invention for this example, the ramification of a “parent” branch results in the creation of two branches according to a vertical limit. In the case where it is impossible to define a vertical limit, that is, when the couples of the “parent” branch all have the same horizontal inclination value αₕ, the division is performed according to a horizontal limit passing between two vertical inclination values αᵥ.

FIGS. 6C and 6D illustrate another possible ramification of branch B, the second selected couple C_{2′} (α_{v2′}=1, α_{h2′}=1) being different from C₂. FIG. 6C illustrates a first division of branch B according to the same vertical limit 12 as that previously defined. The selected first couple C₁ and second couple C_{2′} both belong to branch B₁. Branches B₁ and B₂ take probability value p₁ of first couple C₁ and a new ramification of branch B₁ containing couple C_{2′} is performed until the two selected couples C₁ and C_{2′} are in different branches.

FIG. 6D illustrates the ramification of branch B₁ according to a horizontal limit 13 passing between values 1° and 2° of vertical inclination angle αᵥ. Branch B_{1,1} gathers the couples having a vertical inclination angle value greater than or equal to 2. Branch B_{1,2} gathers the couples having a vertical inclination value strictly smaller than 2. Branch B_{1,2} take probability value p₂ of second couple C_{2′} and branch B_{2,2} takes probability value p₁.

According to another aspect of the implementation mode of the method of the present invention for this example, the successive ramifications of a “parent” branch are successively performed according to a vertical limit and a horizontal limit until the new selected combination is the only one of the selected combinations to belong to a given “child” branch.

1.4. Normalized Probability Values

The probability values, for example p(XS₁, XS₂, XSₙ), obtained from formula (3) are in fact defined to within a constant, normalization constant Z. This constant can be calculated only when the probability values of all combinations (XS₁, XS₂, XSₙ) are known and have been calculated without taking Z into account (Z taken to be equal to 1). Normalization constant Z is then equal to the sum of all the probability values.

In practice, only very few probability values are calculated on construction of the representation of the probability distribution. The probability values calculated for the selected combinations are not normalized.

The present invention provides defining an intermediary normalization constant Zi which is an estimate of normalization constant Z. Normalization constant Zi is calculated during the construction of the probability distribution representation. It is equal to the sum of the probability values of all combinations, the probability value of a combination being that assigned to the branch containing the considered combination.

To easily calculate intermediary normalization constant Zi, the present invention provides assigning a weight to each branch. The weighting of the branches of the last ramification is equal to the product of the probability value associated to the considered branch and of the number of combinations of this branch. The weighting of the other branches is equal to the sum of the weightings of the branches originating from the considered branch and located on the next ramification level. The weighting of the first branch is then equal to intermediary normalization constant Zi.

The weightings are updated on ramification of one of the end branches of the construction tree. The weightings of the branches located between the first branch and the ramifying end branch must be recalculated.

Thus, for the example of construction of the speed probability distribution representation shown in FIGS. 4B to 4G, the weighting of branch B₁ at the end of the first step, FIG. 4B, is 16*p₁. At the end of the second step, FIG. 4C, the weightings of the new branches B₁ and B₂ respectively are 8*p₁ and 8*p₂, and the weighting of branch B is updated and now is 8*p₁+8*p₂. At the end of the third step, FIG. 4D, the weightings of branches B_{1,1} and B_{1,2} both are 4*p₁, and the weighting of branches B₁ and B remains unchanged (respectively 4*p₁+4*p₁=8*p₁ and (4*p₁+4*p₁)+8*p₁=16*p₁) since the probability values assigned to the different speeds have not changed, only the division of the speed values having changed. At the end of the fourth step, FIG. 4E, the weightings of branches B_{1,2,1} and B_{1,2,2} respectively are 2*p₁ and 2*p₃, the weighting of branch B_{1,2} now is 2*p₁+2*p₃, the weighting of branch B₁ is 4*p₁+(2*p₁+2*p₃) and the weighting of branch B is (4*p₁+(2*p₁+2*p₃))+8*p₂. An advantage of the method of the present invention is that it enables rapidly knowing the normalized probability value of the speed since it is not necessary to calculate all the probability values.

1.5. Advantages

The method of the present invention enables representing a great variety of probability distributions, conversely to the so-called “gaussian mixture” method.

The method of the present invention enables obtaining a more or less detailed representation according to the available memory and to the allowed calculation time.

Further, the implementation of an optimized method for the combination selection enables obtaining within a very short time a representation taking up little memory and exhibiting a sufficient accuracy for the areas of space E where the combinations exhibit high probability values. The method of the present invention thus is “multi-resolution” in that the division of space E can be very fine for certain portions and rough for others.

This “multi-resolution” feature of the method of the present invention enables, conversely to existing representations, constructing within a relatively short time and by using memories of reasonable size, probability distribution representations of a large number of control parameters or parameters that can take a large number of values.

2. Selection

Known modes of selection of one of the combinations based on a representation of the probability distribution of the combinations consist of selecting one of the combinations exhibiting the maximum probability or of selecting a combination by random drawing, the principle of which will be recalled hereafter. Other selection criteria such as the selection of the one of the combinations having a predetermined probability value or the selection of one of the combinations having a probability value ranging between two given probability values may however be defined.

2.1. Selection of a Combination of Maximum Probability

According to an implementation mode of the method of the present invention, a memory register is used to store an indication of the branch(es) exhibiting the maximum probability value. The register initially memorizes the first branch of the construction tree, after which it is updated during the construction of the probability distribution representation. At each ramification of a branch, it is checked whether the probability value of the last selected combination is greater than the probability value of the branch memorized by the register, and if such is the case, the register is updated and memorizes the new branch containing the last selected combination.

In the case where the branch of maximum probability ramifies and gives one or several “child” branches of same probability, the register is updated and memorizes all the “child” branches.

The selection of a combination then consists of identifying the branch memorized by the register containing the greater number of combinations and of then selecting one of the combinations of this branch.

2.2. Selection by Random Drawing

A random drawing consists of selecting one of the possible combinations in a way such that a combination exhibiting a high probability stands in a good chance of being selected and a combination exhibiting a low probability stands in a poor chance of being selected. After a great number of random drawings, the probability distribution of the “drawn” combinations is identical to the probability distribution of the initial combinations on which the random drawing method is based.

According to an implementation mode of the method of the present invention, the random drawing of a combination is performed according to a recursive selection method using the construction tree of the representation of the probability distribution.

Starting from the first branch, a second branch, then a third branch are selected, and so on until an end branch of the construction tree is selected. For this purpose, a second branch is selected by performing a random drawing from among the second branches. The second branches exhibiting the highest probabilities stand in the best chance of being selected, and conversely. One of the third branches originating from the selected second branch is similarly selected by performing a random drawing between these third branches, and so on.

In the case where each branch ramifies in two branches, the method of the present invention comprises several steps described hereafter.

In a first step of the method, a number p ranging between 0 and 1 included is randomly selected.

In a second step, sum S of the probability values assigned to the 2 “child” branches resulting from the ramification of the first branch is calculated. Then, for each “child” branch, a new probability value equal to the ratio between the probability value assigned to the considered branch and the calculated sum S is calculated.

In a third step, two contiguous probability intervals are defined between 0 and 1, the first interval being associated with a first child branch, the second interval being associated with the second child branch. The first interval ranges from 0 to and including the probability value of the first child branch and the second interval ranges from this probability value to 1.

In a fourth step, it is identified in which interval number p is located and the “child” branch associated with this interval is selected.

In the case where the selected “child” branch ramifies in other branches, the recursive method is resumed at the first step, the first branch being replaced with the selected “child” branch. The first selected number p may be used again.

In the case where the selected “child” branch does not ramify into other branches, the recursive method stops and one of the combinations of the selected child branch is selected.

The above-mentioned recursive selection method is used in the example of the car/truck system to select a speed or a couple of inclination angles (αᵥ,αₕ).

An advantage of the method of the present invention is that the random drawing method is simple and easy to implement.

2.3. Tree Memorization

Once the decision has been taken, the construction tree can be erased from the memory. It may however be provided, for systems such as the car and the truck, to keep in a “cache” memory the construction trees successively obtained after different samplings of the measurement parameters. The most often used construction trees may be memorized.

In the case where a probability distribution is often used, its representation can be refined by carrying on the ramification of the construction tree of this representation. In the car/truck example, the tree ramification may be carried on for the time allowed between the sampling of the values of cₓ and c_{y} and the time when the values of αᵣₒₜ, v, αᵥ, and αₕ must be selected.

Similarly, in the case where a probability distribution has been much used at a given time, and less afterwards, the accuracy of the probability distribution can be decreased by suppressing more or less end branches of the construction tree.

In the case where it is chosen to calculate a weighting for each branch to know the intermediary normalization constant such as defined hereabove, the weighting values of the branches located between the first branch and the suppressed branch(es) will be updated.

An advantage of the method of the present invention is that it enables refining or simplifying a probability distribution representation. This enables implementing strategies of memorization of different probability distributions to globally improve the successive combinations selections.

### 3. EXAMPLES OF APPLICATION

3.1. Failure Diagnosis

FIG. 7 shows an electric device that comprises several components between an input I and an output O, each component being capable of conducting part of input current K when operating, with no current flowing when the component is defective.

A component A is placed between input I and a first intermediary point 100. Output current KA of component A is equal to 100% of current K when the component operates (and equal to 06 of current K when the component is defective).

Components B and C are placed in parallel between first intermediary point 100 and a second intermediary point 101. Output current KB of component B is at most equal to 40% of current K when component B operates.

Component C is formed of two components C₁ and C₂ in parallel. Each component C₁ and C₂ can conduct up to 30% of current K. Output current KC of component C may thus be equal to 0%, 30%, or 60% of current K, according to whether the two components are defective or the two components are operative.

A component D is placed between point 101 and output O. Component D is formed of eight components D₁ to D₈ in parallel. Each component D₁ to D₈ can conduct up to 15% of current K when it operates. Further, it is necessary that at least six of components D₁ to D₈ operate for component D to operate.

Current KBC entering component D is equal to the sum of current KB and of current KC. Current KBC may be equal to 0%, 30% (only C₁ or C₂ is operative), 40% (only B operates), 60% (C₁ and C₂ are operative), 706 (C₁ or C₂ and B are operative) or 100% (C₁, C₂, and B operate) of current K.

Output current KD of component D may be equal to 0%, 30%, 40%, 60%, 70% (KBC is respectively equal to 0%, 30%, 40%, 60%, and 70% of current K and at least six of components D₁ to D₈ are operative), 90% (KBC is equal to 100% of current K and 6 components D₁ to D₈ are operative) or 100% (KBC is equal to 100% of current K and at least 7 components D₁ to D₈ are operative) or current K.

Each component A, B, C₁, C₂ and D₁ to D₈ can be considered as being a parameter of the device that can take value 0 when the component is defective, and 1 when the component is operative. Output currents KA, KB, KC, KBC, and KD are also considered as being parameters of the device that can take more or less values. Thus, KA and KB can take value 0 or 1 according to whether the current is respectively 0% or 100% of current K. KC can take values 0, 1, or 2 according to whether the current respectively is 0%, 30%, or 60% or current K. KBC can take values 0, 1, 2, 3, 4, or 5 according to whether the current respectively amounts to 0, 30, 40, 60, 70, or 100% of current K. KD can take values 0 to 7 according to whether the current respectively is 0, 30, 40, 60, 70, 90, or 100% of current K.

Probability p(A,B,C₁,C₂,D₁, . . . ,D₈,KA,KB,KC,KBC,KD) for a given combination of all parameters to be pertinent is defined as follows:
p(A,B,C₁,C₂,D₁, . . . ,D₈,KA,KB,KC,KBC,KD)=p(A)p(B)p(C₁)p(C₂)p(D₁)p(D₂)p(D₃)p(D₄)p(D₅)p(D₆)p(D₇)p(D₈) p(KA)p(KB)p(KC)p(KBC)p(KD)p(KA/A)p(KB/B,KA)p(KC/C,KA) p(KBC/KB,KC)p(KD/KBC,D) (4)
where
p(A), p(B), p(C₁), p(C₂), p(D₁) to p(D₈), p(KA), p(KB), p(KC), p(KBC), and p(KD) respectively are the probabilities for A, B, C₁, C₂, KA, KB, KC, KBC, and KE to have a given value,
p(KA/A) is the probability for KA to have a given value knowing the value of A,
p(KB/B,KA) is the probability for KB to have a given value knowing the value of B and of KA,
p(KC/C,KA) is the probability for KC to have a given value knowing the value of C and of KA,
p(KBC/KB,KC) is the probability for KBC to have a given value knowing the value of KB and of KC,
p(KD/KBC,D) is the probability for KD to have a given value knowing the value of KBC and of D.

Simple probabilities p(A) to p(KD) can be defined from databases noting down the failure cases having appeared in tests performed by the firm manufacturing the device. Conditional probabilities p(KA/A) to p(KD/KBC,D) can easily be defined based on the device description. For example:
p(KA=0%/A=0)=1
p(KA=100%/A=0)=0
p(KA=0%/A=1)=0
p(KA=100%/A=1)=1

In a failure diagnosis of the device, the current at a point of the device (KA, KB, KC, KBC, or KD) can be measured and/or the operating state of one or several components of the device (A, B, C₁, C₂, D₁ to D₈) can be considered. Once one or several currents have been sampled and/or one or several components have been analyzed, it can be determined which components are likely to fail (diagnosis 1) or what current is likely to flow at a point of the device (diagnosis 2).

According to the performed diagnosis, parameters A, B, C₁, C₂, D₁ to D₈, KA, KB, KC, KBC, and KC can be either specific parameters, the value of which is desired to be determined, or measurement parameters, since the current or the operating state is measured, or non-retained parameters since their value is not desired to be determined and their value is not measured.

In diagnosis 1, the measurement parameters are one or several currents, for example, KBC, and the specific parameters are one or several components, in this example, components A, B, C₁, and C₂ located upstream of current KBC. After a sampling of the value of current KBC, a representation of the probability distribution of the combinations of values of parameters A, B, C₁, and C₂ is constructed according to the method of the present invention, knowing the value of measurement parameter KBC. Probability p(A,B,C₁,C₂/KBC) for a combination (A,B,C₁,C₂) to represent the state of the device, knowing the value of KBC, can be calculated as previously by summing up all the probabilities p(A,B,C₁,C₂,D₁, . . . ,D₈,KA,KB,KC,KBC,KE) for all the parameter values not retained in this inference (D₁ to D₈, KA, KB, KC, KD). It will be first desired to identify a first combination, that exhibiting the maximum probability, to perform a first repair. If this repair appears to be insufficient or unfounded, a second combination exhibiting the highest probability after the first combination will be identified, and so on.

In diagnosis 2, the control parameter will be the current which is desired to be known, for example, KBC, where the measurement parameters may be one or several of the other parameters. After a sampling of the value of the measurement parameters, a representation of the probability distribution of the possible values of current KBC will be constructed according to the method of the present invention. The value of current KBC exhibiting the maximum probability is then selected.

3.2. Figure Recognition

FIG. 8 shows an image 200 of a figure written by hand which is desired to be identified. The image is broken down into 64 squares or pixels of identical sizes. For each pixel, a grey level representing the surface area taken up by the lines of the figure in the considered pixel is measured on a scale from 0 to 16.

The system comprises a single parameter to be determined (or specific parameter) CHIFFRE that can take values 0 to 9 and 64 measurement parameters Pix[i], i being an integer ranging between 1 and 64, that can each take values 0 to 15.

Probability p(CHIFFRE,Pix[1], . . . ,Pix[64]) for a given combination of values of all the parameters to be possible, is defined as follows:
p(CHIFFRE,Pix[1], . . . ,Pix[64])=p(CHIFFRE)*p(Pix[1]/CHIFFRE)* . . . p(Pix[64]/CHIFFRE) (5)
where p(CHIFFRE) is the probability to have a given figure, and p(Pix[i]/CHIFFRE) is the probability to have a given grey level for pixel Pix[i], knowing the figure.

It is generally considered that FIGS. 0 to 9 are equiprobable and thus that p(CHIFFRE) is equal to 1/10. Conditional probabilities p(Pix[i]/CHIFFRE) are defined at the end of a training phase consisting of measuring the grey levels of each pixel for different models of handwritten figures. Each probability p(Pix[i]/CHIFFRE) can be defined by a histogram (with 16 columns) normalized according to the Laplace law.

The recognition of a figure comprises a first phase of measurement of the grey level of each pixel. In a second phase, a representation of the probability distribution of the figures is constructed based on formula (5) and on the method of the present invention, knowing the grey levels of each pixel. The selection of a figure consists of identifying the figure exhibiting the maximum probability.

3.3. Evaluation of a Transport Cost

A shipping company dispatches by cargo goods from a European port to another port. The dispatched goods can be of a great variety: food products, medicine, electric appliances, or clothes. Different sorts of containers are used for the storage of the goods in the cargo and in the port of arrival. The containers may be refrigerating and of different sizes.

The shipping company desires to rapidly determine, in a telephone conversation, for example, transport expense estimates knowing the port of departure (PortDep) and the port of arrival (PortArr), the type of transported goods (Mar), the container used (Cont), the client (Cl), and the month (M) in which the transport will occur. These parameters, previously input on determination of the estimate, form the measurement parameters of the transport system.

Further, the company has in its possession a whole set of information especially relative to the container preparation time in the European port of departure (TdP), the shipping time (TdTM) (outward or back, the containers are full on the outward trip and empty on the way back), the waiting time of the container in the port of arrival (TdA), the time of container unloading at the client's (TdDC), the container reconditioning time when back in Europe (TdRE), the times being counted in days.

Similarly, information is available relating to the daily cost of the renting of a container (CdLJ), the daily cost of immobilization of a container for its reconditioning (CdIJ), the shipping cost (CdTM), the repair cost of a container (CdR).

The total transport cost (CT) is the sum of the total cost of the container renting (CdLT=CdLJ*(TdP+2*TdTM+TdA+TdDC+TdRE)), of the total container immobilization cost (CdIT), of the shipping cost (CdTM=CdIT*TdRE), of the cost of the load balancing in the cargo (CdE), and of the cost of a container repair (CdR).

The model of the joint probability distribution of all the previously-defined parameters is constructed based on the independent probability distributions defined for each time parameter (TdP, TdTM, TdA, TdDC, and TdRE), and for each cost parameter (CDLT, CdIT, CdTM, CdE, CdR, CT). The probability values are obtained from a set of data acquired along the company's lifetime. For example, the probability distributions of the container preparation time in the port of departure (TdP) knowing the nature of the good (Mar) are a gaussian family. The probability distributions of the shipping costs (CdTM) knowing the type of container (Cont), the port of departure (PortDep), the port of arrival (PortArr), and the transported goods (Mar) are Dirac functions.

Generally, the total transport cost (CT) is desired to be defined without detailing the intermediary costs. In this case, there is a single parameter (or specific parameter) to determine: the total cost (CT). To rapidly provide a total cost, a representation of the probability distribution of the possible total costs CT is constructed according to the method of the present invention, knowing the measurement parameters (PortDep, PortArr, Mar, Cont, Cl, and M). The vendor first wants to know what the maximum cost is, for example, 2,000 euros. He then establishes a first estimate by possibly taking a 10% margin with respect to the maximum cost, then offers 2,200 euros. In the case where the client does not accept this price, the vendor can then estimate the average cost or the cost range containing for example 90% of the possible cost values. The average cost can easily be calculated by dividing intermediary normalization constant Zi by the number of possible total costs. The vendor will then establish a second estimate by taking a margin that may be smaller with respect to the average cost or with respect to one of the costs of the cost range.

The established estimate may also detail all the costs, in which case the measurement control parameters of the system are (CdLT, CdIT, CdTM, CdE, CdR). The total cost is then calculated based on the retained cost combination.

This example of application shows that based on a representation, the combination of maximum probability can easily be determined, the average value and the standard deviation of the values of a parameter can be calculated, and one of the combinations exhibiting a given probability can be selected. The method of the present invention thus enables easily implementing several selection criteria.

Of course, the present invention is likely to have various alterations, modifications, and improvements which will readily occur to those skilled in the art. In particular, it will be within the abilities of those skilled in the art to define the branch ramification method most adapted to the studied system. Similarly, it will be within the abilities of those skilled in the art to define new criteria of the selection of a combination based on the tree-shaped representation of the probability distribution.

1. A method for determining the value to be given to a set of specific parameters of a system based on the values of a set of measurement parameters of this system, where each of the parameters can take a finite number of values, the system being associated with a means for providing a probability value for any combination of values of the specific parameters, said probability value being all the greater as the selection of the considered combination is pertinent knowing the value of the measurement parameters, the method comprising the steps of:
noting down the value of each measurement parameter;
constructing a tree-shaped representation of the probability distribution of all the possible combinations of values of the specific parameters corresponding to the noted down values,
the set of combinations, forming a first branch, being divided into several subsets of combinations, forming second branches, each subset gathering combinations having close specific parameter values, where each second branch can similarly divide into several third branches and so on,
a probability value being assigned to each branch, this probability value being that obtained for one of the combinations of the considered branch or for one of the combinations of one of the branches from which the considered branch originates;
selecting according to a predefined selection criterion one of the combinations of values of the specific parameters based on the representation of the previously-constructed tree-shaped probability distribution.

2. The method of claim 1, wherein the branches resulting from the division of a same branch are at the number of two and contain the same number of combinations, the first branch dividing in two second branches, where each second branch can divide in two third branches and so on.

3. The method of claim 2, wherein the division of a branch in two branches comprises the steps of:
a) selecting a combination different from the combinations having already been used to define the probability value of the existing branches and calculating the probability of this selected combination;
b) dividing the so-called “parent” branch containing the selected combination in two so-called “child” combinations; and
in the case where the selected combination and the “parent” combination used to define the probability value of the parent branch belong to the same child branch, assigning to the two child branches the probability value of the parent branch and dividing the child branch containing the selected combination by resuming the method at step b), this child branch becoming the parent branch, and
in the case where the selected combination and the parent combination do not belong to the same child branch, assigning the probability value of the selected combination to the child branch containing the selected combination and assigning the probability value of the parent combination to the other child branch.

4. The method of claim 1, wherein the selection criterion consists of selecting one of the combinations exhibiting the maximum probability.

5. The method of claim 2, wherein the selection of a combination consists of implementing the recursive method comprising the steps of:
a) randomly selecting a number p ranging between 0 and 1;
b) calculating the sum of the probability values assigned to the two so-called child branches resulting from the division of the first branch, and calculating for each child branch a new probability value equal to the ratio between the probability value assigned to this child branch and the calculated sum;
c) defining two contiguous probability intervals between 0 and 1, the first interval being associated with a first child branch, the second interval being associated with the second child branch, the first interval ranging from 0 to and including the probability value of the first child branch and the second interval ranging from the probability value to 1;
d) identifying in which interval number is to be found and selecting the child branch associated with this interval, and
in the case where the selected child branch ramifies into other branches, resuming the recursive method at step a), the first branch being replaced with the selected child branch, otherwise
e) selecting one of the combinations of the selected child branch.

6. The method of claim 1, wherein the selection criterion consists of selecting one of the combinations having a probability value which is predetermined or ranging between two given probability values.

7. The method of claim 1, wherein the probability values assigned to each branch are not normalized and can be greater than one.

8. The method of claim 7, wherein a weighting is assigned to each branch, the weighting of the branches of the last ramifications being equal to the product of the probability value assigned to this branch and of the number of combinations of this branch, the weighting of the other branches being equal to the sum of the weightings of the branches originating from the considered branch and being on the next ramification level.

9. The method of claim 8, wherein the probability value assigned to each branch can be normalized, the normalized probability value of a branch being obtained by dividing the probability value of this branch by the weighting assigned to the first branch of the tree.

10. The method of claim 3, wherein the selection of a combination is performed by implementing a method generating combinations having high probability values.

11. The method of claim 1, wherein the representation of the probability distribution of all the combinations is memorized and may be subsequently refined by the creation of additional branches, or may be simplified by the suppression of certain branches.

12. The method of claim 1, wherein the number of values likely to be taken by a parameter is artificially increased, the probability value of a combination of values of control parameters, among which at least a value of one of the parameters corresponds to an added value, is zero.
